(19) United States
(12) Patent Application Publication
(10) Pub. No.: US 2022/0299716 A1
(43) Pub. Date: Sep. 22, 2022

(54) FIBER CARRIER

(71) Applicant: COMMSCOPE TECHNOLOGIES LLC, Hickory, NC (US)

(72) Inventor: Lawrence Joseph SORENSON, Bloomington, MN (US)

(73) Assignee: COMMSCOPE TECHNOLOGIES LLC, Hickory, NC (US)

(21) Appl. No.: 17/639,229

(22) PCT Filed: Aug. 21, 2020
(86) PCT No.: PCT/US2020/047535

§ 371 Date: Feb. 28, 2022

Related U.S. Application Data
(60) Provisional application No. 62/894,328, filed on Aug. 30, 2019.
(60) Provisional application No. 63/036,313, filed on Jun. 8, 2020.

(51) Int. Cl. G02B 6/38

(52) U.S. Cl. CPC G02B 6/3887; G02B 6/3897

(57) ABSTRACT

A fiber carrier for retaining and organizing optical cables can include a frame structure including a base defining an open area and a cable retention station supported by the frame structure, the cable retention station being located above the open area. A method for joining fiber optic cables to fiber optic connectors can include providing a plurality of fiber optic connectors mounted to a carrier, mounting a fiber carrier to the carrier, the fiber carrier including a cable retention station, inserting fiber optic cables into the fiber optic connectors and securing the fiber optic cables to the fiber optic connectors with a curable material, and supporting each of the fiber optic cables at the fiber retentions station at least until the curable material has cured.

### CROSS-REFERENCE TO RELATED APPLICATIONS

This application is being filed on Aug. 21, 2020 as a PCT International Patent Application and claims the benefit of U.S. Patent Application Ser. No. 62/894,328, filed on Aug. 30, 2019, and claims the benefit of U.S. Patent Application Ser. No. 63/036,313, filed on Jun. 8, 2020, the disclosures of which are incorporated herein by reference in their entireties.

### BACKGROUND

As demand for telecommunications increases, fiber optic networks are being extended into more and more areas. As a result, there is a need for manufacturing efficiencies including for the fixtures and methods used in development of fiber optic devices, such as fiber optic connectors.

### SUMMARY

A fiber carrier for retaining and organizing optical cables is disclosed. The fiber carrier can include a frame structure including a base defining an open area, and a cable retention station supported by the frame structure, the cable retention station being located above the open area.

In some examples, the cable retention station defines one or more cable retention slots configured to removably retain and support a cable.

In some examples, the cable retention station is a mounting clip removably mounted to the frame.

In some examples, the mounting clip defines one or more cable retention slots configured to removably retain and support a cable.

In some examples, the fiber carrier includes a second mounting clip removably mountable to the frame and defining one or more second cable retention slots.

In some examples, each of the one or more cable retention slots includes a first sidewall, a second sidewall, and a protrusion extending from the first sidewall towards the second sidewall.

In some examples, the frame structure includes an attachment feature for securing the frame structure to a connector carrier.

In some examples, the attachment feature includes at least one magnet.

In some examples, a fiber carrier for retaining and organizing optical cables can include a frame structure, the frame structure including a base configured to mount onto a fiber optic connector carrier, and a first retaining clip removably mountable to the frame structure, the first retaining clip defining one or more first cable retention slots defining a first width.

In some examples, the fiber carrier further includes a second retaining clip removably mountable to the frame structure, the second retaining clip defining one or more second cable retention slots, the second cable retention slots defining a second width greater than the first width.

In some examples, each of the one or more first cable retention slots includes a first sidewall, a second sidewall, and a protrusion extending from the first sidewall towards the second sidewall.

In some examples, the frame structure includes an attachment feature for securing the frame structure to a connector carrier.

In some examples, the attachment feature includes at least one magnet.

In some examples, the first mounting clip is mountable to the frame without separate fasteners.

In some examples, the first mounting clip is mountable to the frame with a slide-fit connection.

A method for joining fiber optic cables to fiber optic connectors can include the steps of providing a plurality of fiber optic connectors mounted to a carrier, mounting a fiber carrier to the carrier, the fiber carrier including a cable retention station, inserting fiber optic cables into the fiber optic connectors and securing the fiber optic cables to the fiber optic connectors with a curable material, supporting each of the fiber optic cables at the fiber retentions station at least until the curable material has cured.

In some examples, the method can include supporting each of the inserted fibers includes inserting each of the fiber optic cables into a cable retention slot of the fiber retention station.

In some examples, the method can include securing a mounting clip to a frame structure of the fiber carrier, the mounting clip defining the cable retention station.

In some examples, the method can include selecting a mounting clip defining the cable retention station, the mounting clip being configured to retain fiber optic cables having a pre-determined diameter.

In some examples, the method can include securing the mounting clip to a frame of the fiber carrier.

A portable optical fiber and connector assembly station is disclosed. The station can include a fiber carrier for retaining and organizing optical cables and including a frame structure including a base defining an open area and a cable retention station supported by the frame structure, the cable retention station being located above the open area. The station can also include a connector carrier removably connected to the fiber carrier, the connector carrier being configured to secure a plurality of optical connectors extending into the open area such that the plurality of optical connectors are below the cable retention station.

In some examples, the cable retention station is a mounting clip removably mounted to the frame.

In some examples, the mounting clip defines one or more cable retention slots configured to removably retain and support a cable.

In some examples, the frame structure includes an attachment feature for securing the frame structure to the connector carrier.

In some examples, the attachment feature includes at least one magnet.

A fiber carrier for retaining and organizing optical cables can include a frame structure, the frame structure including a base configured to mount onto a fiber optic connector carrier and can include a first retaining clip removably mountable to the frame structure. The first retaining clip can define one or more first cable retention slots defining a first width. The first retaining clip includes a first main body removably mountable to the frame structure and a second main body pivotally connected to the first main body, the second main body being rotatable between an open position in which cables can be installed and removed from the first retaining clip and a closed position in which cables are secured within the first retaining clip.

In some examples, each of the one or more first cable retention slots includes a first sidewall, a second sidewall, and a protrusion extending from the first sidewall towards the second sidewall, and wherein the second main body includes a plurality of projections received into a space between the first and second sidewalls when the second main body is in a closed position.

In some examples, the first main body includes a first attachment feature for connecting with a second attachment feature of the second main body for securing the second main body in the closed position.

In some examples, the first and second attachment features are magnets.

In some examples, the frame structure includes guide channels for aligning the cables.

A variety of additional inventive aspects will be set forth in the description that follows. The inventive aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a perspective view of a fiber carrier having features in accordance with the present disclosure, the fiber carrier being shown with a first retainer clip connected to a frame structure and an additional alternative second fiber retainer clip connectable to the frame structure.

FIG. 2 is a top view of the fiber carrier shown in FIG. 1.

FIG. 3 is an exploded perspective view of the fiber carrier and retainer clips shown in FIG. 1.

FIG. 4 is a front view of the frame structure of the fiber carrier shown in FIG. 1.

FIG. 5 is a side view of the frame structure shown in FIG. 4.

FIG. 6 is a top view of the frame structure shown in FIG. 4.

FIG. 7 is a bottom view of the frame structure shown in FIG. 4.

FIG. 8 is a front view of the first retainer clip of the fiber carrier shown in FIG. 1.

FIG. 9 is a rear view of the first retainer clip shown in FIG. 8.

FIG. 10 is a top view of the first retainer clip shown in FIG. 8.

FIG. 11 is a bottom view of the first retainer clip shown in FIG. 8.

FIG. 12 is a first side view of the first retainer clip shown in FIG. 8.

FIG. 13 is a second side view of the first retainer clip shown in FIG. 8.

FIG. 14 is an enlarged front view of a portion of the first retainer clip shown in FIG. 8, with a cable schematically shown as being retained in one of a plurality of retention slots of the first retainer clip.

FIG. 15 is an enlarged front view of a portion of the second retainer clip shown in FIG. 1, with a cable schematically shown as being retained in one of a plurality of retention slots of the second retainer clip.

FIG. 16 is a front view of the fiber carrier shown in FIG. 1 mounted to a connector carrier holding a plurality of fiber optic connectors.

FIG. 17 is a top view of the fiber carrier and connector carrier shown in FIG. 16.

FIG. 18 is a front view of the fiber carrier and connector carrier shown in FIG. 16, wherein fiber optic cables have been inserted into the fiber optic connectors and affixed to the first retainer clip.

FIG. 19 is a perspective view of a second example frame structure usable with the fiber carrier shown in FIG. 1.

FIG. 20 is a front view of the frame structure shown in FIG. 19.

FIG. 21 is a top view of the frame structure shown in FIG. 19.

FIG. 22 is perspective view of a third retainer clip usable with the fiber carrier frame structures shown in FIGS. 1 and 19, wherein the retainer clip is in an open position.

FIG. 23 is a front view of the retainer clip shown in FIG. 22.

FIG. 24 is a perspective view of the retainer clip shown in FIG. 22, wherein the retainer clip is in a closed position.

FIG. 25 is a top view of the retainer clip shown in FIG. 24.

FIG. 26 is a bottom view of the retainer clip shown in FIG. 24.

FIG. 27 is a perspective view of a fourth retainer clip usable with the fiber carrier frame structures shown in FIGS. 1 and 19, wherein the retainer clip is in an open position.

FIG. 28 is a front view of the retainer clip shown in FIG. 27.

FIG. 29 is a perspective view of the retainer clip shown in FIG. 27, wherein the retainer clip is in a closed position.

FIG. 30 is a top view of the retainer clip shown in FIG. 29.

FIG. 31 is a bottom view of the retainer clip shown in FIG. 29.

FIG. 32 is a perspective view of a fifth retainer clip usable with the fiber carrier frame structures shown in FIGS. 1 and 19, wherein the retainer clip is in an open position.

FIG. 33 is a front view of the retainer clip shown in FIG. 32.

FIG. 34 is a perspective view of the retainer clip shown in FIG. 32, wherein the retainer clip is in a closed position.

FIG. 35 is a top view of the retainer clip shown in FIG. 34.

FIG. 36 is a bottom view of the retainer clip shown in FIG. 34.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

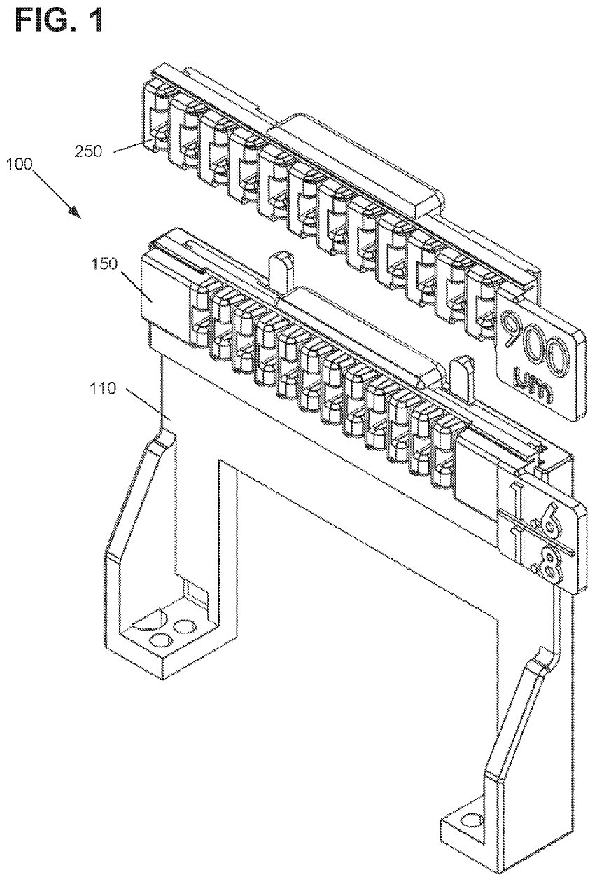

Referring to FIG. 1, a fiber carrier 100 is presented. The fiber carrier 100 is for supporting and retaining fiber optic cables. When fiber optic cables are initially connected to fiber optic connectors, they are secured together with a material that must be cured. While the material is curing, it is ideal if the fiber optic cables are held in a stationary position with respect to the connectors. The fiber carrier 100 performs this function. The fiber carrier 100 is also designed to be portable such that the fiber carrier 100, with or without the below-described connector carrier 200 can be easily carried manually by a fabricator from one work station to another work station.

In one aspect, the fiber carrier 100 includes a frame structure 110 to which a selected retaining clip 150, 250 can be mounted. As shown, a first retaining clip 150 is mounted to the frame structure 110 while a second retaining clip 250 is shown without being connected to the frame structure 110. The frame structure 110 is configured to receive either the first mounting clip 150 or the second mounting clip 250. The retaining clips 150, 250 differ in that each is configured to retain a different range of fiber optic cable diameters. For example, the first mounting clip 150 is configured to retain 1.6 to 1.8 mm fiber optic cables while the second mounting clip 250 is configured to retain 900 μm fiber optic cables.

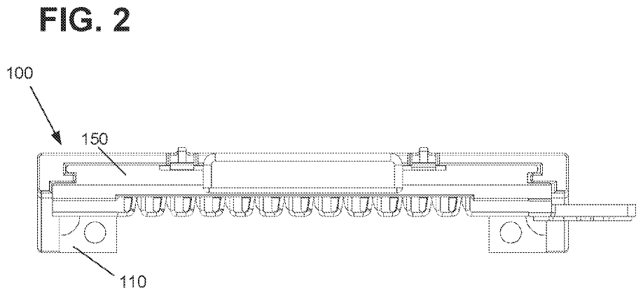

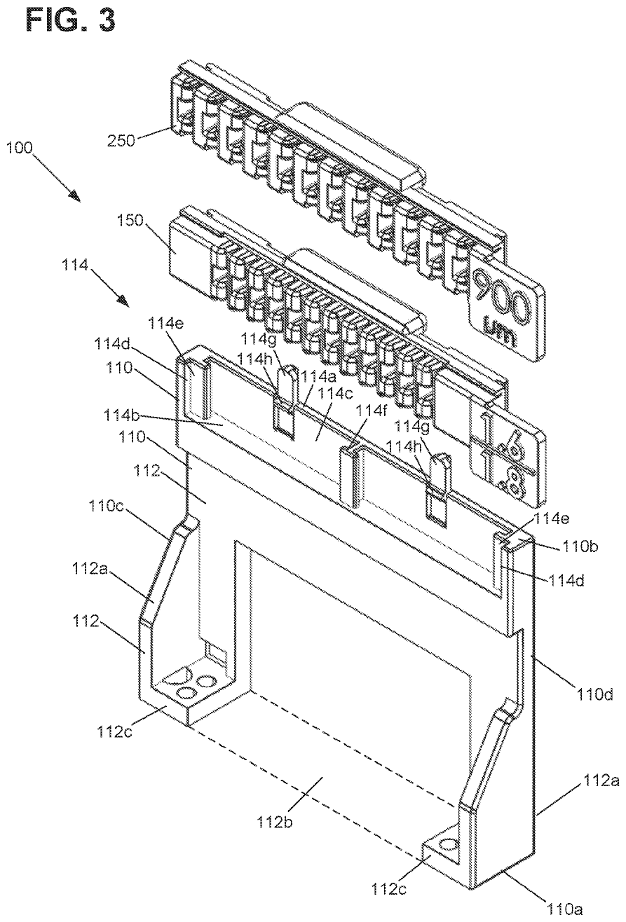

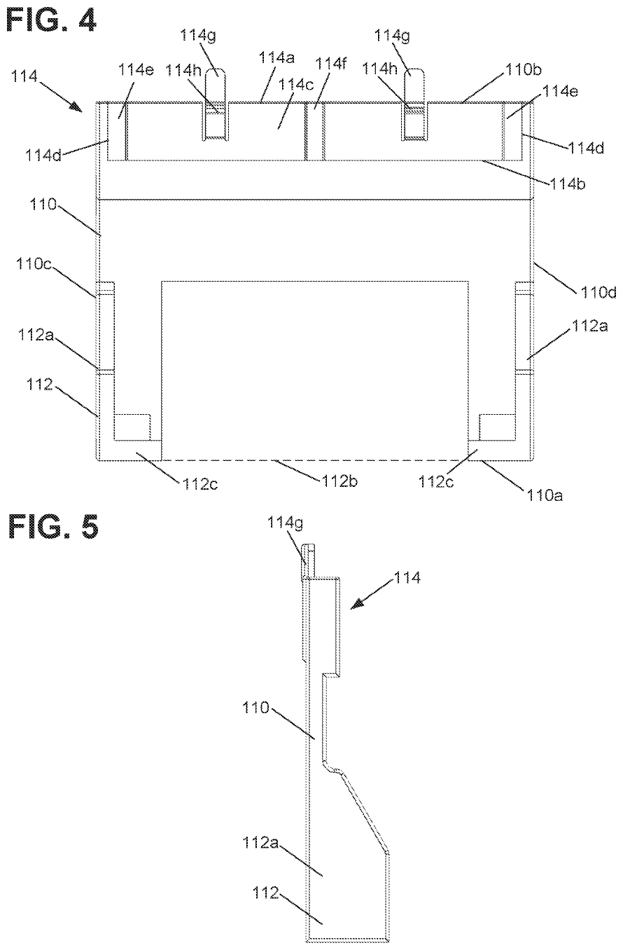

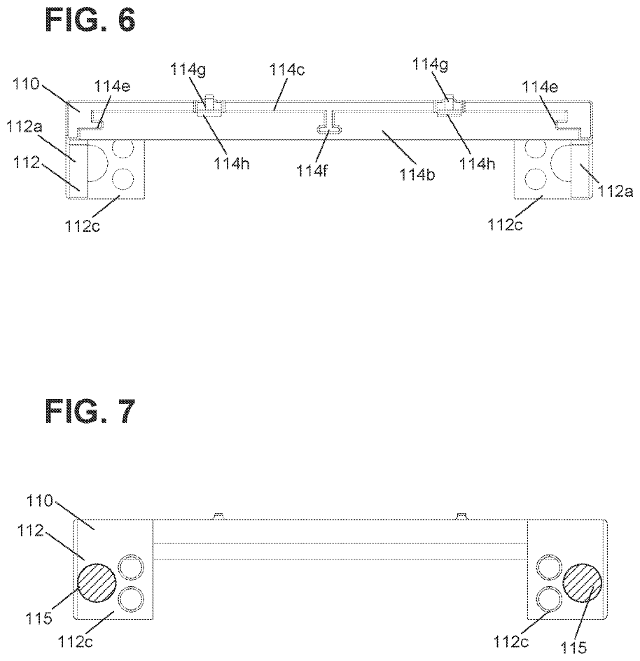

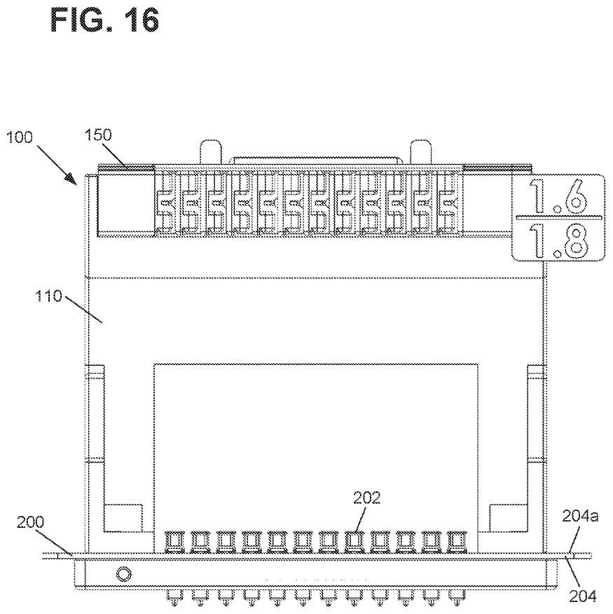

Referring to FIGS. 2 to 5, the frame structure 110 is shown in further detail. In one aspect, the frame structure 110 is formed as a unitary component extending from a bottom end 110a to a top end 110b and between opposite sides 110c, 110d. The frame structure 110 defines a base portion 112 proximate the bottom end 110a. The base 112 may include one or more attachment features 115 enabling the base portion 112 to be connected to a connector carrier 200 (see FIGS. 16 to 18). In the example shown, the attachment features 115 are magnets and the connector carrier 200 is formed from a metallic material. Other configurations are possible, for example, mechanical fasteners or foregoing an attachment system. The base portion 112 is shown as being configured with two separate leg portions 112a that define an open area 112b therebetween. The open area 112b, schematically shown at FIG. 1, is the area within which the fiber optic connectors 202 held by the connector carrier 200 reside during the assembly process. To enhance the stability of the frame structure 110, the legs 112a can be provided with relatively wider feet portions 112c that also house the attachment features 114.

In one aspect, the frame structure 110 defines a first part 114 of a connection arrangement proximate the top end 110b. The first part 114 of the connection arrangement is configured to engage with a second part 116 of the connection arrangement, defined on the interchangeable retaining clips 150, 250 to enable the retaining clips 150, 250 to be secured to the frame structure 110. In one aspect, the first part 114 of the connection arrangement defines a channel 114a defined by a bottom wall 114b, an end wall 114c, and a pair of sidewalls 114d. Within the channel 114a, and extending from the sidewalk 114d, is a pair of projections 114e. Another t-shaped projection 114f is provided in the center of the channel 114a extending along the end wall 114c. The first part 114 is also shown as being provided with a pair of deflectable members 114g extending upwardly from the end wall 114b. As is discussed later, the projections 114e and 114f are slidably received into correspondingly shaped recesses in the retaining clips 150, 250 when the retaining clips 150, 250 are inserted into the channel 114a. The deflectable members 114g are provided with latch portions 114h that engage with corresponding surfaces on the retaining clips 150, 250 such that the retaining clips 150, 250 are secured into the channel 114a. An installed retaining clip 150, 250 can be slidably removed from the channel 114a once both deflectable members 114g are bent away from the retaining clips 150, 250 such that the latch portions 114h are clear of the retaining clips 150, 250.

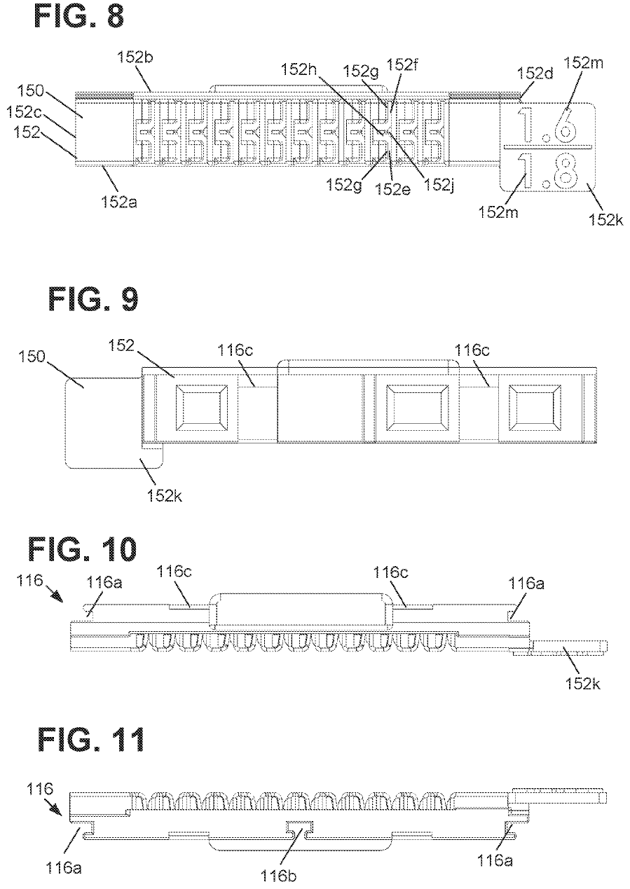

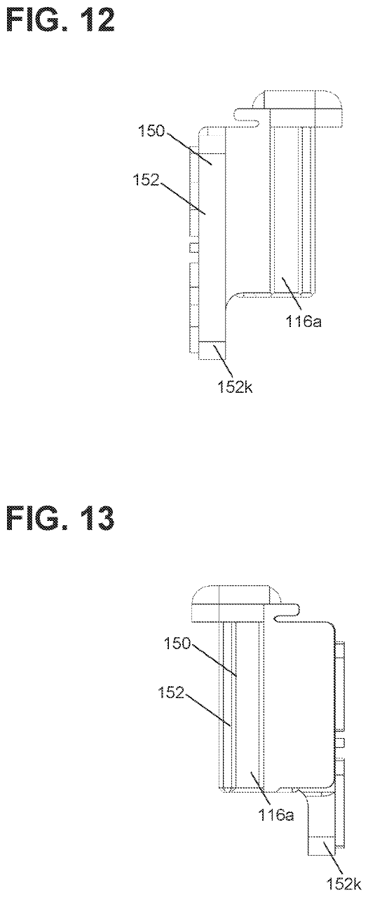

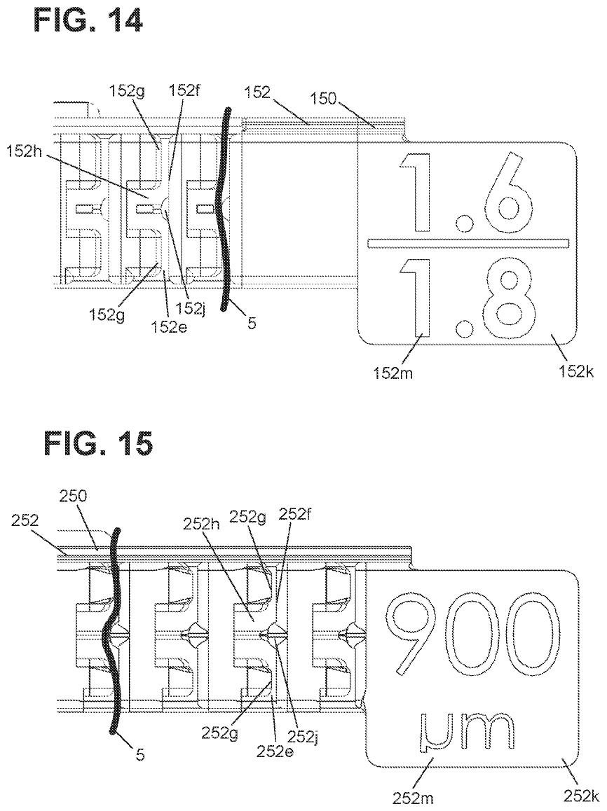

Referring to FIGS. 8 to 14, the retaining clip 150 is shown in further detail. In one aspect, the retaining clip 150 defines a cable retention station defining a plurality of locations at which a cable can be supported. As shown, the retaining clip 150 defines a main body 152 extending between a bottom side 152a and a top side 152b, and between first and second sides 152c, 152d. In the example shown, each of the cable-supporting locations has a cable retention slot 152e defined by a first sidewall 152f and an opposite second sidewall 152g. In one aspect, the sidewall 152g is formed by two sidewall portions separated by a gap 152h. A protrusion 152j is also provided that extends from the first sidewall 152f and towards the gap 152h. As shown at FIG. 14, the sidewalls 152f, 152g, the gap 152h, and the protrusion 152j collectively define the cable retention slot 152e defining a circuitous or tortious pathway, wherein a cable must be bent around the protrusion 152j such that the bent portion of the cable 5 extends into the gap 152k By pressing a portion of the cable 5 into the cable retention slot 152e, around the protrusion 152j and towards the gap 152i, the cable 5 is temporarily secured into the retention slot 152e. The cable 5 can be easily removed from the cable retention slot 152e by pulling on the cable 5 on either side of the clip 150 in a direction away from the clip 150. This same structure is provided for the retaining clip 250, as illustrated at FIG. 15. In the example shown, the retaining clips 150, 152 are provided with 12 cable retention slots 152e, 252e. However, more or fewer can be provided, as desired.

Still referring to FIGS. 8 to 14, and as mentioned previously, the retaining clip 150 is provided with a second part 116 of a connection arrangement. As shown, the second part 116 includes a pair of slots 116a located at the ends 152c, 152d of the main body 152, wherein the slots 116a have a complementary shape with the projections 114e of the frame structure 110. A t-shaped slot or recess 116b is also provided on the main body 152 having a complementary shape with the t-shaped projection 114f. Accordingly, when the retaining clip 150 is aligned directly above the frame structure 110 such that the slots 116a, 116b are aligned with the projections 114e, 114f, the retaining clip 150 can be slid onto the frame structure such that the projections 114e, 114f are received into the slots 116a, 116b until the bottom side 152a of the retaining clip rests against the bottom wall 114b of the frame structure connection arrangement first part 114. In this position, the latch portions 114h of the deflectable members 114g are snapped over sidewalk or ledges 116c formed in the main body 152 to secure the retaining clip 150 within the channel 114a. As noted above, the retaining clip 150 can be removed from the channel 150 by bending the deflectable members 114g until the latch members 114g are disengaged from the sidewalls or ledges 116c. Although the retaining clip 150 is shown with recesses or slots 116a, 1.16b and the frame structure 110 is shown as having protrusions 114e, 114f, it should be understood that the retaining clip 150 could be provided with projections and the frame structure 110 could be provided with protrusions, and that each of the retaining clip 150 and frame structure could be provided with both protrusions and recesses. Also, other means for connecting the retaining clip 150 to the frame structure 110 are also possible, for example through the use of mechanical fasteners or magnets. Although providing interchangeable retaining clips 150, 250 enhances the modularity of the design, it is also possible to provide a fiber carrier 100 in which the frame 110 and the features of the retaining clip 150 are provided as a single piece, unitary component.

The retaining clip 150 can also be provided with a handle portion 152k at the end 152d of the main body to enable an operator to install and remove the retaining clip 150 into and out of the frame structure 110. In the example shown, the handle portion 152k is provided with indicia 152m to indicate the cable sizes that can be retained within the cable retention slots 152e.

The above-provided description for the retaining clip 150 is applicable for the retaining clip 250. However, it should be noted that the cable retention slots 252e of the retaining clip 250 have a narrower interior dimension to retain smaller diameter fiber optic cables 5. In one aspect, the interior dimension can be characterized as the distance or spacing between the first and second sidewalls 252f, 252g of the retaining clip 250, which is smaller than the distance or spacing between the first and second sidewalls 152f, 252g of the retaining clip 150. In one aspect, the second sidewalls 252g can be configured as deflectable members such that the insertion of a cable 5 into a cable retention slot 152e results in a slight interference fit. With such a configuration, a spring force is generated by the deflecting second sidewalls 252g against the cable 5 to retain the cable 5 within the cable retention slot 152e.

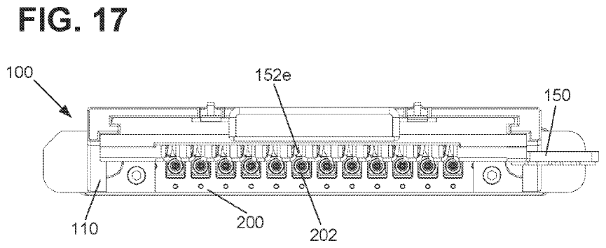

Referring to FIGS. 16 to 17, the fiber carrier 100 is shown as having been mounted onto a connector carrier 200 to which a plurality of fiber optic connectors 202 are mounted. Notably, a retaining clip 150 has been selected and mounted to frame 110 that has a number of cable retention slots equaling the number of fiber optic connectors 202. One example of a connector carrier 200 with which the fiber carrier 100 can be used is shown and described in U.S. Provisional Patent Application Ser. No. 62/826,546, filed on Mar. 29, 2019 and entitled FIBER OPTIC CONNECTOR FABRICATION CARRIER, the entirety of which is incorporated herein by reference. In one aspect, the connector carrier 200 has a flange 204 defining an upper face 204a against which the base 112 of the fiber carrier 100 rests. Where the flange 204 is formed from a metal material, the fiber carrier 100 can be secured to the connector carrier 200 with magnets 115, as described previously. In one aspect, the fiber optic connectors 202 are located within the open area 112b defined by the base portion 112 of the frame 110. With the retaining clip 150 mounted to the frame 110, the cable retention slots 152e are located vertically above the open area 112b and the fiber optic connectors 202. By use of the term, “vertically above” it is meant to indicate that the cable retention slots 152e are located at a higher elevation or plane relative to the open area 112b, and not necessarily directly above the open area 112b. In the example shown, the cable retention slots 152e, and the cable retention station defined by the slots 152e, are both vertically above and directly above at least a portion of the open area 112b. In the example shown, the cable retention slots 152e are vertically above, but not fully directly above the connectors 202, when the fiber carrier 100 is mounted to the connector carrier 200 shown in FIGS. 16 and 17.

Once the fiber carrier 100 has been mounted to or placed over the connector carrier 200, fiber optic cables 5 can be connected to the fiber optic connectors 202, as shown at FIG. 18. As each fiber optic cable 5 is inserted into a connector 202 and a curable material has been introduced to join the cable 5 to the connector 202, the cable 5 can be secured within the cable retention slot 152e above the connector 202 such that the cable 5 is maintained in a fixed position without putting undue stress onto the connector 202 and the curable material during the curing process. Once all of the ends of the cables 5 have been inserted into the connectors 202, the curable material has been introduced, and the cables 5 have been secured into the fiber retention slots 152e defining the cable retention station, the operator can then either leave the assembly in place until curing is complete, or can move the fiber carrier 100 and connector carrier 200 to a curing station for curing while a new connector carrier 200 and fiber carrier 100 are brought to the installation station.

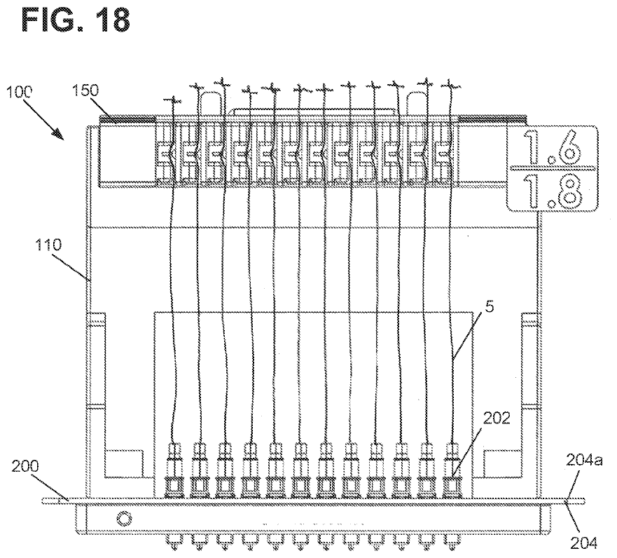

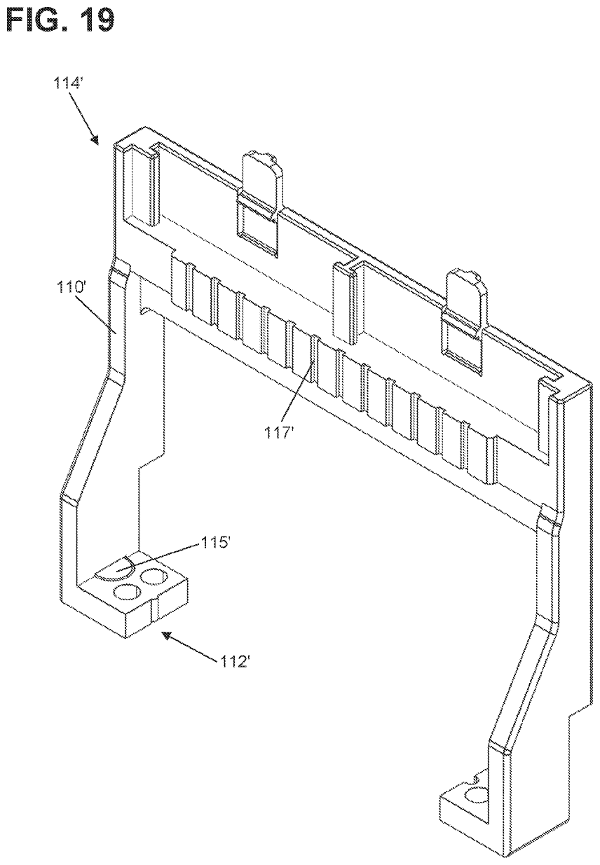

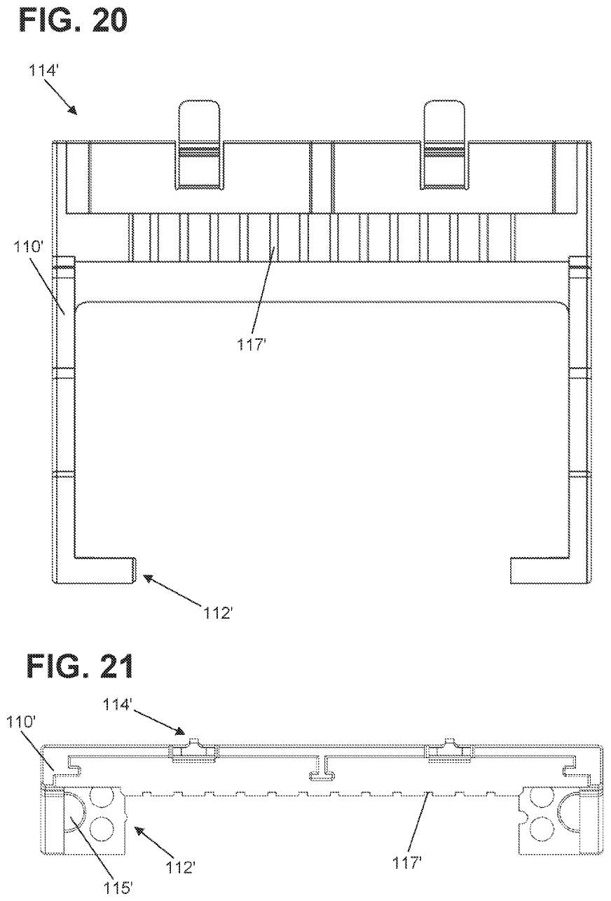

Referring to FIGS. 19 to 36, additional examples of a frame 110′ and retaining clips 150′, 250′, and 350 are disclosed. Many of the features in these examples are the same as those previously described and need not be repeated here. Rather, the primary differences are discussed. One such difference is that the frame 110′ is provided with channels for additionally aligning the cables when held in the frame 110′. Another such difference is that the retaining clips 150′, 250′, and 350 are provided with hinged first and second bodies such that the retained cables can be further secured within the retaining clips. It is noted that the retaining clips 150′, 250′, 350 can be used with the frame 110 or the frame 110′ and that the retaining clips 150, 250 can also be used with the frame 110′. It is also noted that the frame 110′ can be used with the connector carrier 200 in the same manner as previously described for frame 110.

Referring to FIGS. 19 to 21, the frame structure 110′ is shown in further detail. In one aspect, the frame structure 110′ is formed as a unitary component containing the previously described attachment features 114′ at a top end of the frame structure 110′ and containing a base 112′ and attachment features 115′ at a bottom end of the frame structure 110′. In one aspect, the base 112′ is provided with a wider cut-out portion in comparison to the base 112 such that greater access to the connection carrier 200 can be facilitated. In another aspect, the frame structure 110′ is provided with a plurality of channels 117′. The channels 117′ are formed as recesses in the main body of the frame structure 110′ and are aligned vertically below the cable retention slots of the retaining clip attached to the frame structure 110′. Accordingly, the channels 117′ can be used as an alignment aid or guide when inserting the cables 5 into the cable retention slots during assembly. In the example shown, the channels 117′ have rectangular cross-sectional shape. However, other shapes are possible, such as a semi-circular cross-sectional shape.

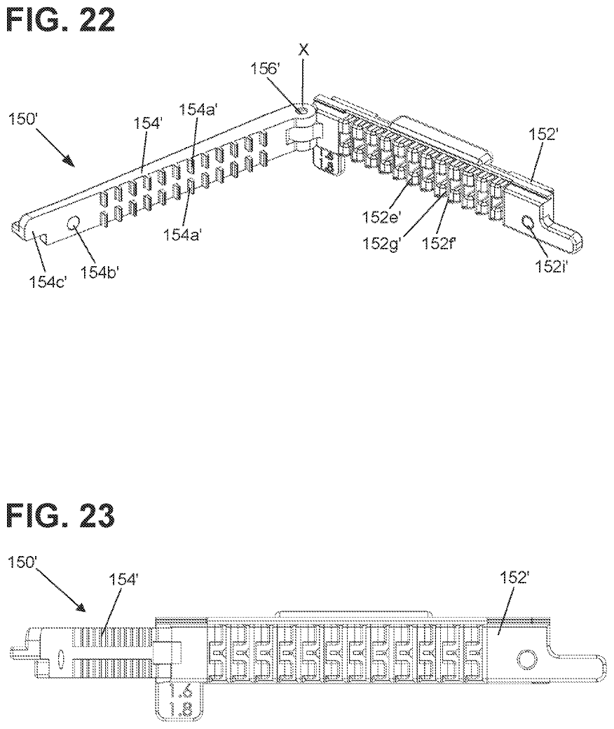

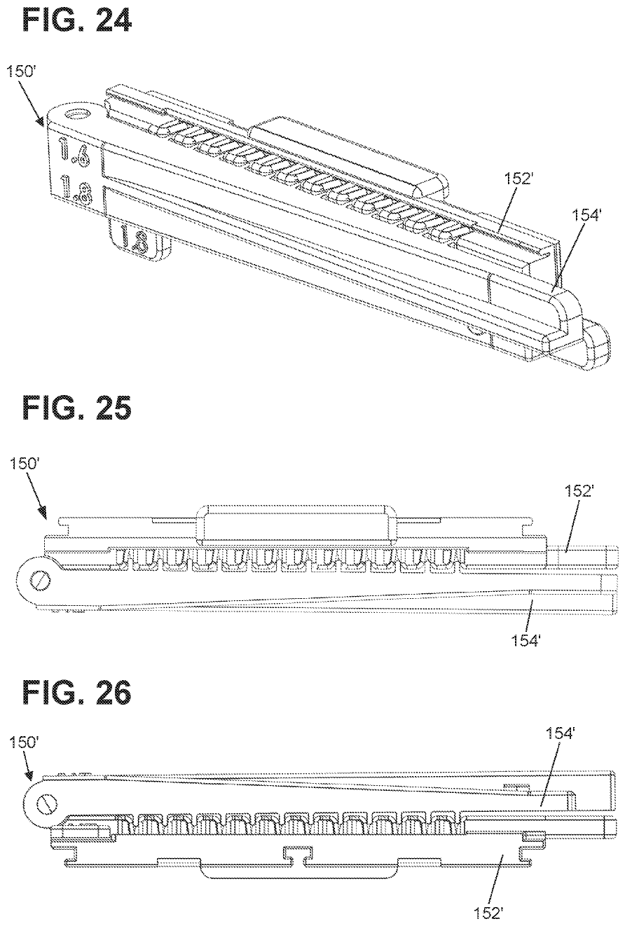

Referring to FIGS. 22 to 26, the retaining clip 150′ is presented. In one aspect, the retaining clip 150′ is configured to retain 1.6 to 1.8 mm fiber optic cables. FIGS. 22 and 23 show the retaining clip 150′ in an open position while FIGS. 24 to 26 show the retaining clip 150′ in a closed position. In the open position, cables 5 can be removed from the retaining clip 150′. In the closed position, the cables 5 are secured within the retaining clip 150′. As shown, the retaining clip 150′ has a first main body 152 and a second main body 154′ hingedly connected to the first main body 152′ about a pivot axis X. In the example shown, the first and second main bodies 152′, 154′ are connected to each other by a pin 156′. Other attachment systems can be used. For example, pins or projections and recesses or openings can be provided on each part for a snap-fit type connection without the use of a third component, such as a pin.

In one aspect, the first main body 152′ can be provided with a first attachment feature 152i′ and the second main body 154′ can be provided with a second attachment feature 154c′ such that the retaining clip 150′ can be positively held in the closed position. In the example shown, the attachment features 152i′ and 154b′ are magnets. Other configurations are possible, such as separate or integral clips or fasteners. The second main body 154′ is also shown as being provided with a handle portion 154c′ such that the second main body 154′ can be more easily rotated by an operator between the open and closed positions. Similarly to the retaining clip 150, the main body 152′ includes a plurality of cable retention slots 152e′ for retaining cables 5 in the same manner as previously described.

In one aspect, the second main body 154′ includes a plurality of guides or projections 154a′. In the example shown, two projections 154a′ are provided for each cable retention slot 152e′ such that the contact with and force on the bent middle portion of the cable 5 within the cable retention slot 152e′ is avoided. The projections 154a′ are also provided with a concave curved shape complementary to the convex curved shape defined by the sidewalls 152e′ and 152f′. When the retaining clip 150′ is placed in the closed position, the projections 154a′ are received into each cable retention slot 152e′ such that each projection 154a′ extends into the space defined between the first sidewall 152f and the opposite second sidewall 152g′. Accordingly, when a cable 5 is received into the cable retention slot 152e′ and the retaining clip 150′ is placed in the closed position, the projections 154a′ block the cable 5 from exiting the cable retention slot 152e′, With such a configuration, the cables 5 are prevented from inadvertently being pulled out of the cable retention slots 152e during the assembly process and/or during transport or movement of the fiber carrier 100.

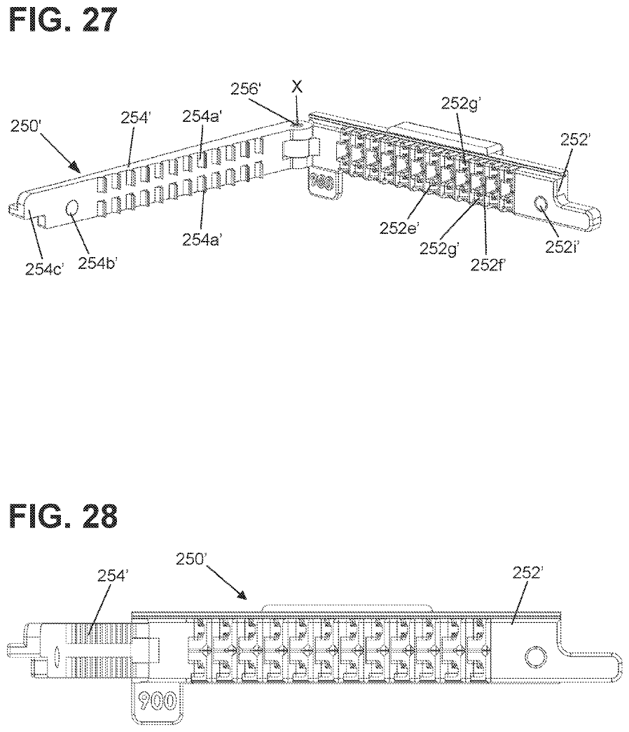

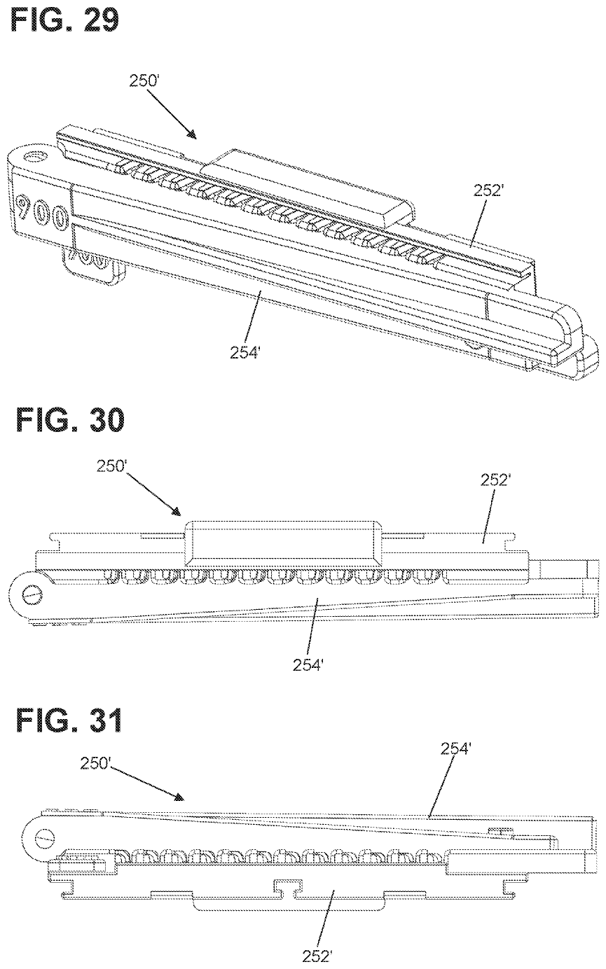

Referring to FIGS. 27 to 31, the retaining clip 250′ is presented. In one aspect, the retaining clip 250′ is configured to retain 900 um fiber optic cables. FIGS. 27 and 28 show the retaining clip 250′ in an open position while FIGS. 29 to 31 show the retaining clip 250′ in a closed position. In the open position, cables 5 can be removed from the retaining clip 250′. In the closed position, the cables 5 are secured within the retaining clip 250′. As shown, the retaining clip 250′ has a first main body 152′ and a second main body 154′ hingedly connected to the first main body 152′ about a pivot axis X. In the example shown, the first and second main bodies 252′, 254′ are connected to each other by a pin 256′. Other attachment systems can be used. For example, pins or projections and recesses or openings can be provided on each part for a snap-fit type connection without the use of a third component, such as a pin.

In one aspect, the first main body 252′ can be provided with a first attachment feature 252i′ and the second main body 254′ can be provided with a second attachment feature 254c′ such that the retaining clip 250′ can be positively held in the closed position. In the example shown, the attachment features 252i′ and 254b′ are magnets. Other configurations are possible, such as separate or integral clips or fasteners. The second main body 254′ is also shown as being provided with a handle portion 254c′ such that the second main body 254′ can be more easily rotated by an operator between the open and closed positions. Similarly to the retaining clip 250, the main body 252′ includes a plurality of cable retention slots 252e′ for retaining cables 5 in the same manner as previously described.

In one aspect, the second main body 254′ includes a plurality of guides or projections 254a′. In the example shown, two projections 254a′ are provided for each cable retention slot 252e′ such that the contact with and force on the bent middle portion of the cable 5 within the cable retention slot 252e′ is avoided. The projections 254a′ are also provided with a concave curved shape complementary to the convex curved shape defined by the sidewalls 252e′ and 252f. When the retaining clip 250′ is placed in the closed position, the projections 254a′ are received into each cable retention slot 252e′ such that each projection 254a′ extends into the space defined between the first sidewall 252f′ and the opposite second sidewall 252g′. Accordingly, when a cable 5 is received into the cable retention slot 252e′ and the retaining clip 250′ is placed in the closed position, the projections 254a′ block the cable 5 from exiting the cable retention slot 252e′. With such a configuration, the cables 5 are prevented from inadvertently being pulled out of the cable retention slots 252e during the assembly process and/or during transport or movement of the fiber carrier 100.

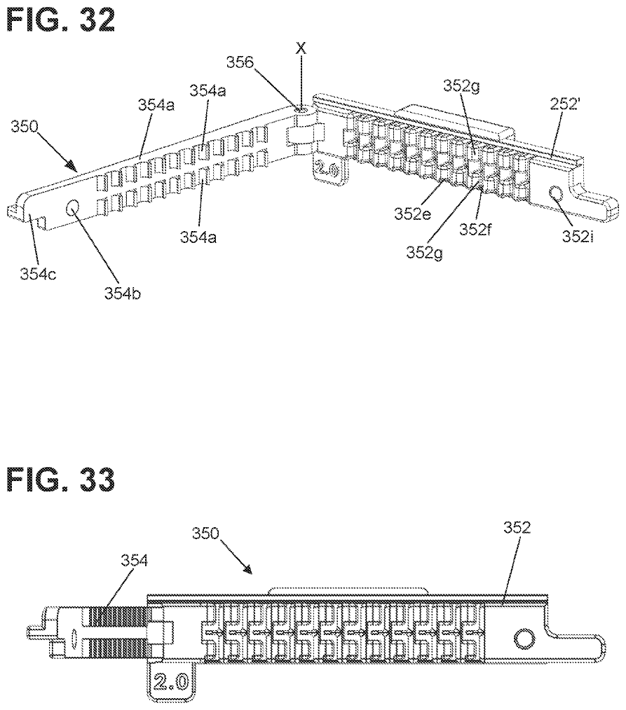

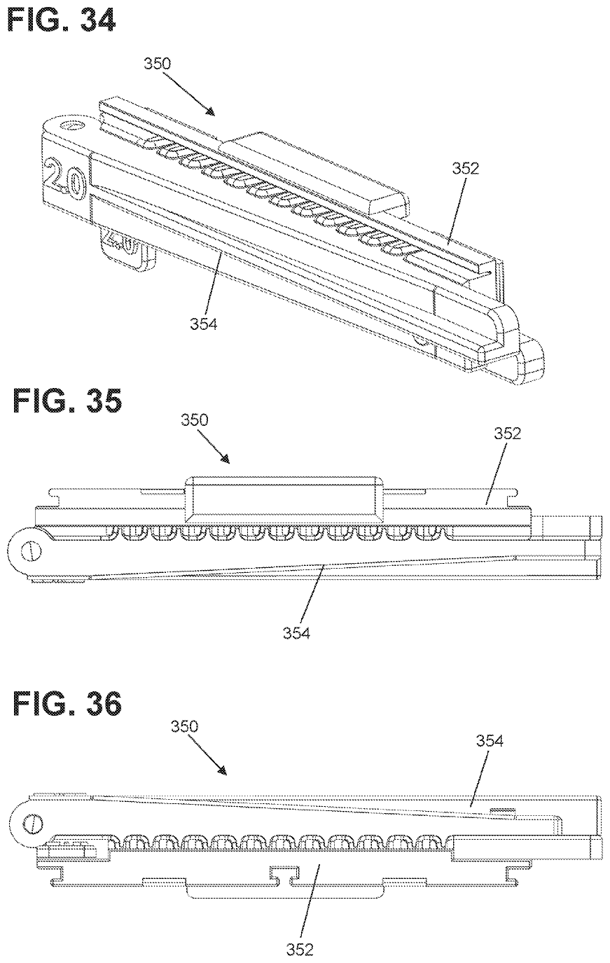

Referring to FIGS. 32 to 36, the retaining clip 350 is presented. In one aspect, the retaining clip 350 is configured to retain 2.0 mm fiber optic cables. FIGS. 32 and 33 show the retaining clip 350 in an open position while FIGS. 34 to 36 show the retaining clip 350 in a closed position. In the open position, cables 5 can be removed from the retaining clip 350. In the closed position, the cables 5 are secured within the retaining clip 350. As shown, the retaining clip 350 has a first main body 352 and a second main body 352 hingedly connected to the first main body 352 about a pivot axis X. In the example shown, the first and second main bodies 352, 354 are connected to each other by a pin 356. Other attachment systems can be used. For example, pins or projections and recesses or openings can be provided on each part for a snap-fit type connection without the use of a third component, such as a pin.

In one aspect, the first main body 352 can be provided with a first attachment feature 352i and the second main body 354 can be provided with a second attachment feature 354c such that the retaining clip 350 can be positively held in the closed position. In the example shown, the attachment features 352i and 354b are magnets. Other configurations are possible, such as separate or integral clips or fasteners. The second main body 354 is also shown as being provided with a handle portion 354c such that the second main body 354 can be more easily rotated by an operator between the open and closed positions. Similarly to the retaining clips 150,250, the main body 352 includes a plurality of cable retention slots 352e for retaining cables 5 in the same manner as previously described.

In one aspect, the second main body 354 includes a plurality of guides or projections 354a. In the example shown, two projections 354a are provided for each cable retention slot 352e such that the contact with and force on the bent middle portion of the cable 5 within the cable retention slot 352e is avoided. The projections 354a are also provided with a concave curved shape complementary to the convex curved shape defined by the sidewalls 352e and 352f. When the retaining clip 350 is placed in the closed position, the projections 354a are received into each cable retention slot 352e such that each projection 354a extends into the space defined between the first sidewall 352f and the opposite second sidewall 352g. Accordingly, when a cable 5 is received into the cable retention slot 352e and the retaining clip 350 is placed in the closed position, the projections 354a block the cable 5 from exiting the cable retention slot 352e. With such a configuration, the cables 5 are prevented from inadvertently being pulled out of the cable retention slots 352e during the assembly process and/or during transport or movement of the fiber carrier 100.

Many materials can be used for the components of the disclosed fiber carrier 100. For example, the components of the fiber carrier 100 can be formed from metal and/or polymeric materials.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A fiber carrier for retaining and organizing optical cables, the fiber carrier comprising:
a) a frame structure including a base defining an open area; and
b) a cable retention station supported by the frame structure, the cable retention station being located above the open area.

2. The fiber carrier of claim 1, wherein the cable retention station defines one or more cable retention slots configured to removably retain and support a cable.

3. The fiber carrier of claim 1 or any other preceding claim, wherein the cable retention station is a mounting clip removably mounted to the frame.

4. The fiber carrier of claim 3 or any other preceding claim, wherein the mounting clip defines one or more cable retention slots configured to removably retain and support a cable.

5. The fiber carrier of claim 4 or any other preceding claim, further comprising:
a) a second mounting clip removably mountable to the frame and defining one or more second cable retention slots.

6. The fiber carrier of claim 2 or any other preceding claim, wherein each of the one or more cable retention slots includes a first sidewall, a second sidewall, and a protrusion extending from the first sidewall towards the second sidewall.

7. The fiber carrier of claim 1 or any other preceding claim, wherein the frame structure includes an attachment feature for securing the frame structure to a connector carrier.

8. The fiber carrier of claim 5 or any other preceding claim, wherein the attachment feature includes at least one magnet.

9. A fiber carrier for retaining and organizing optical cables, the fiber carrier comprising:
a) a frame structure, the frame structure including a base configured to mount onto a fiber optic connector carrier; and
b) a first retaining clip removably mountable to the frame structure, the first retaining clip defining one or more first cable retention slots defining a first width.

10. The fiber carrier of claim 9 or any other preceding claim, further comprising:
a) a second retaining clip removably mountable to the frame structure, the second retaining clip defining one or more second cable retention slots, the second cable retention slots defining a second width greater than the first width.

11. The fiber carrier of claim 9 or any other preceding claim, wherein each of the one or more first cable retention slots includes a first sidewall, a second sidewall, and a protrusion extending from the first sidewall towards the second sidewall.

12. The fiber carrier of claim 9 or any other preceding claim, wherein the frame structure includes an attachment feature for securing the frame structure to a connector carrier.

13. The fiber carrier of claim 12 or any other preceding claim, wherein the attachment feature includes at least one magnet.

14. The fiber carrier of claim 9 or any other preceding claim, wherein the first mounting clip is mountable to the frame without separate fasteners.

15. The fiber carrier of claim 14 or any other preceding claim, wherein the first mounting clip is mountable to the frame with a slide-fit connection.

16. A method for joining fiber optic cables to fiber optic connectors, the method comprising:
a) providing a plurality of fiber optic connectors mounted to a carrier;
b) mounting a fiber carrier to the carrier, the fiber carrier including a cable retention station;
c) inserting fiber optic cables into the fiber optic connectors and securing the fiber optic cables to the fiber optic connectors with a curable material; and
d) supporting each of the fiber optic cables at the fiber retentions station at least until the curable material has cured.

17. The method of claim 16 or any other preceding claim, wherein the step of supporting each of the inserted fibers includes inserting each of the fiber optic cables into a cable retention slot of the fiber retention station.

18. The method of claim 16 or any other preceding claim, further comprising:
a) securing a mounting clip to a frame structure of the fiber carrier, the mounting clip defining the cable retention station.

19. The method of claim 16 or any other preceding claim, further comprising:
a) selecting a mounting clip defining the cable retention station, the mounting clip being configured to retain fiber optic cables having a pre-determined diameter.

20. The method of claim 19 or any other preceding claim, further comprising:
a) securing the mounting clip to a frame of the fiber carrier.

21. A portable optical fiber and connector assembly station, the assembly station comprising:
a) a fiber carrier for retaining and organizing optical cables, the fiber carrier comprising:
i. a frame structure including a base defining an open area; and
ii. a cable retention station supported by the frame structure, the cable retention station being located above the open area; and
b) a connector carrier removably connected to the fiber carrier, the connector carrier being configured to secure a plurality of optical connectors extending into the open area such that the plurality of optical connectors are below the cable retention station.

22. The portable optical fiber and connector assembly station of claim 21 or any other preceding claim, wherein the cable retention station is a mounting clip removably mounted to the frame.

23. The portable optical fiber and connector assembly station of claim 22 or any other preceding claim, wherein the mounting clip defines one or more cable retention slots configured to removably retain and support a cable.

24. The portable optical fiber and connector assembly station of claim 21 or any other preceding claim, wherein the frame structure includes an attachment feature for securing the frame structure to the connector carrier.

25. The portable optical fiber and connector assembly station of claim 24 or any other preceding claim, wherein the attachment feature includes at least one magnet.

26. A fiber carrier for retaining and organizing optical cables, the fiber carrier comprising:
a) a frame structure, the frame structure including a base configured to mount onto a fiber optic connector carrier; and
b) a first retaining clip removably mountable to the frame structure, the first retaining clip defining one or more first cable retention slots defining a first width, the first retaining clip including a first main body removably mountable to the frame structure and a second main body pivotally connected to the first main body, the second main body being rotatable between an open position in which cables can be installed and removed from the first retaining clip and a closed position in which cables are secured within the first retaining clip.

27. The fiber carrier of claim 26 or any other preceding claim, wherein each of the one or more first cable retention slots includes a first sidewall, a second sidewall, and a protrusion extending from the first sidewall towards the second sidewall, and wherein the second main body includes a plurality of projections received into a space between the first and second sidewalls when the second main body is in a closed position.

28. The fiber carrier of claim 26 or any other preceding claim, wherein the first main body includes a first attachment feature for connecting with a second attachment feature of the second main body for securing the second main body in the closed position.

29. The fiber carrier of claim 26 or any other preceding claim, wherein the first and second attachment features are magnets.

30. The fiber carrier of claim 26 or any other preceding claim, wherein the frame structure includes guide channels for aligning the cables.
